(19) United States
(12) Patent Application Publication
(10) Pub. No.: US 2025/0264699 A1
(43) Pub. Date: Aug. 21, 2025

(54) Wide-Angle Lens Assembly

(71) Applicant: Asia Optical Co., Inc., Taichung (TW)

(72) Inventor: Jia-Sin Chen, Taichung (TW)

(21) Appl. No.: 18/914,360

(22) Filed: Oct. 14, 2024

(30) Foreign Application Priority Data
Feb. 19, 2024 (CN) 202410185585.2

(51) Int. Cl. G02B 13/06; G02B 9/62

(52) U.S. Cl. CPC G02B 13/06; G02B 9/62

(57) ABSTRACT

A wide-angle lens assembly includes a first lens, a second lens, a third lens, a fourth lens, a fifth lens, and a sixth lens. The first lens is with negative refractive power. The second lens is with refractive power. The third lens is with positive refractive power. The fourth lens is with negative refractive power and includes a concave surface facing an image side. The fifth lens is with refractive power and includes a convex surface facing the image side. The sixth lens is with refractive power and includes a convex surface facing an object side. The first lens, the second lens, the third lens, the fourth lens, the fifth lens, and the sixth lens are arranged in order from the object side to the image side along an optical axis.

### BACKGROUND OF THE INVENTION

### Field of the Invention

The present invention relates to a wide-angle lens assembly.

### Description of the Related Art

The current development trend of a wide-angle lens assembly is toward large field of view. Additionally, the wide-angle lens assembly is developed to have high resolution in accordance with different application requirements. However, the known wide-angle lens assembly can't satisfy such requirements. Therefore, the wide-angle lens assembly needs a new structure in order to meet the requirements of large field of view and high resolution at the same time.

### BRIEF SUMMARY OF THE INVENTION

The invention provides a wide-angle lens assembly to solve the above problems. The wide-angle lens assembly of the invention is provided with characteristics of an increased field of view, an increased resolution, and still has a good optical performance.

The wide-angle lens assembly in accordance with an exemplary embodiment of the invention includes a first lens, a second lens, a third lens, a fourth lens, a fifth lens, and a sixth lens. The first lens is with negative refractive power. The second lens is with refractive power. The third lens is with positive refractive power. The fourth lens is with negative refractive power and includes a concave surface facing an image side. The fifth lens is with refractive power and includes a convex surface facing the image side. The sixth lens is with refractive power and includes a convex surface facing an object side. The first lens, the second lens, the third lens, the fourth lens, the fifth lens, and the sixth lens are arranged in order from the object side to the image side along an optical axis. The wide-angle lens assembly satisfies at least one of the following conditions: 1.03≤BFL/f≤1.22; 0.44≤|f/R31|≤0.57; 0.5≤R52/R61≤1.3; 17.2 degrees/mm≤FOV/f≤17.5 degrees/mm; 45 degrees≤FOV/Fno≤47 degrees; 2.58 mm≤f/Fno≤2.72 mm; wherein f is an effective focal length of the wide-angle lens assembly, R31 is a radius of curvature of an object side surface of the third lens, R52 is a radius of curvature of an image side surface of the fifth lens, R61 is a radius of curvature of an object side surface of the sixth lens, BFL is an interval from an image side surface of the sixth lens to an image plane along the optical axis, FOV is a maximum field of view of the wide-angle lens assembly, and Fno is a F-number of the wide-angle lens assembly.

In another exemplary embodiment, the second lens is with positive refractive power; the fifth lens is with positive refractive power; and the sixth lens is with positive refractive power.

In yet another exemplary embodiment, the first lens includes a concave surface facing the image side; the second lens includes a convex surface facing the object side; the third lens is a biconvex lens and includes a convex surface facing the object side and another convex surface facing the image side; the fourth lens is a biconcave lens and further includes another concave surface facing the object side; and the fifth lens is a meniscus lens and further includes a concave surface facing the objet side.

In another exemplary embodiment, the second lens is a meniscus lens and further includes a concave surface facing the image side; and the sixth lens is a meniscus lens and further includes a concave surface facing the image side.

In yet another exemplary embodiment, the first lens is a meniscus lens and further includes a convex surface facing the object side.

In another exemplary embodiment, the first lens is a biconcave lens and further includes another concave surface facing the object side.

In yet another exemplary embodiment, the second lens is a biconvex lens and further includes another convex surface facing the image side; and the sixth lens is a biconvex lens and further includes another convex surface facing the image side.

In another exemplary embodiment, the wide-angle lens assembly further includes a stop disposed between the third lens and the fourth lens.

In yet another exemplary embodiment, the wide-angle lens assembly satisfies at least one of following conditions: 2≤Vd1/Vd2≤3; 3.4≤TTL/BFL≤4.2; 2.2≤|R21/R12|≤6.3; 1.35≤f1/f4≤2.05; wherein Vd1 is an Abbe number of the first lens, Vd2 is an Abbe number of the second lens, TTL is an interval from an object side surface of the first lens to the image plane along the optical axis, BFL is the interval from the image side surface of the sixth lens to the image plane along the optical axis, R12 is a radius of curvature of an image side surface of the first lens, R21 is a radius of curvature of an object side surface of the second lens, f1 is an effective focal length of the first lens, and f4 is an effective focal length of the fourth lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1, 6, and 11 are lens layout and optical path diagrams of wide-angle lens assemblies in accordance with a first, second, and third embodiments of the invention, respectively;

FIGS. 2, 3, 4, and 5 depict a field curvature diagram, a distortion diagram, a modulation transfer function diagram, and a through focus modulation transfer function diagram of the wide-angle lens assembly in accordance with the first embodiment of the invention, respectively;

FIGS. 7, 8, 9, and 10 depict a field curvature diagram, a distortion diagram, a modulation transfer function diagram, and a through focus modulation transfer function diagram of the wide-angle lens assembly in accordance with the second embodiment of the invention, respectively; and

FIGS. 12, 13, 14, and 15 depict a field curvature diagram, a distortion diagram, a modulation transfer function diagram, and a through focus modulation transfer function diagram of the wide-angle lens assembly in accordance with the third embodiment of the invention, respectively.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a wide-angle lens assembly including a first lens, a second lens, a third lens, a fourth lens, a fifth lens, and a sixth lens. The first lens is with negative refractive power. The second lens is with refractive power. The third lens is with positive refractive power. The fourth lens is with negative refractive power and includes a concave surface facing an image side. The fifth lens is with refractive power and includes a convex surface facing the image side. The sixth lens is with refractive power and includes a convex surface facing an object side. The first lens, the second lens, the third lens, the fourth lens, the fifth lens, and the sixth lens are arranged in order from the object side to the image side along an optical axis. The wide-angle lens assembly satisfies at least one of the following conditions: 1.03≤BFL/f≤1.22; 0.44≤|f/R31|≤0.57; 0.5≤R52/R61≤1.3; 17.2 degrees/mm≤FOV/f≤17.5 degrees/mm; 45 degrees≤FOV/Fno≤47 degrees; 2.58 mm≤f/Fno≤2.72 mm; wherein f is an effective focal length of the wide-angle lens assembly, R31 is a radius of curvature of an object side surface of the third lens, R52 is a radius of curvature of an image side surface of the fifth lens, R61 is a radius of curvature of an object side surface of the sixth lens, BFL is an interval from an image side surface of the sixth lens to an image plane along the optical axis, FOV is a maximum field of view of the wide-angle lens assembly, and Fno is a F-number of the wide-angle lens assembly. A wide-angle lens assembly of the present invention is a preferred embodiment of the present invention when the wide-angle lens assembly satisfies the above features and at least one of the above conditions.

Referring to Table 1, Table 3, and Table 5, wherein Table 1, Table 3, and Table 5 show optical specification in accordance with a first, second, and third embodiments of the invention, respectively.

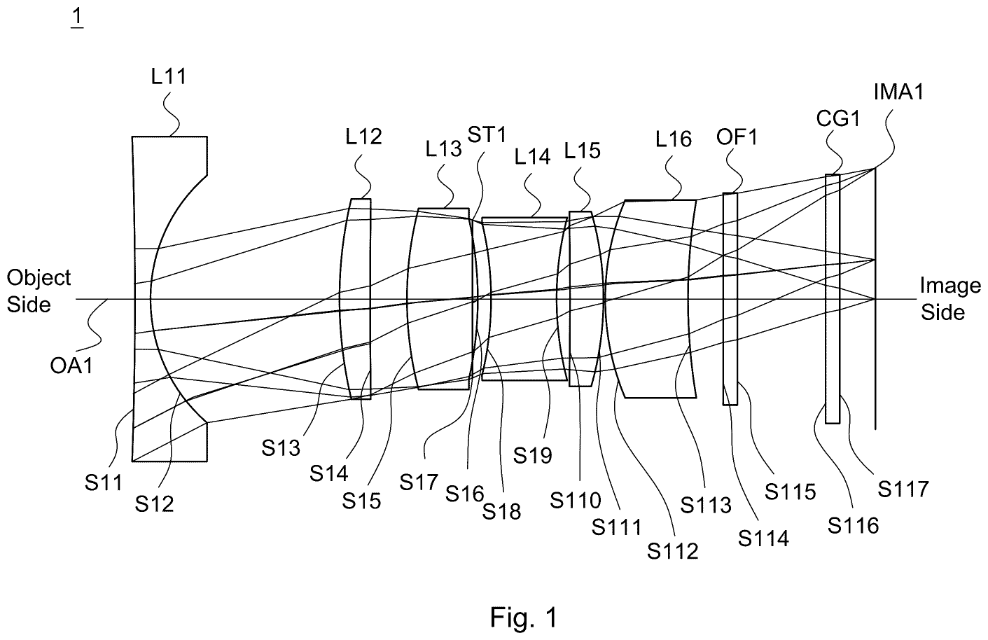

FIGS. 1, 6, and 11 are lens layout and optical path diagrams of wide-angle lens assemblies in accordance with a first, second, and third embodiments of the invention, respectively. The first lenses L11, L21, L31 are with negative refractive power, wherein the image side surfaces S12, S22, S32 are concave surfaces and both of the object side surfaces S11, S21, S31 and image side surfaces S12, S22, S32 are spherical surfaces.

The second lenses L12, L22, L32 are with positive refractive power, wherein the object side surfaces S13, S23, S33 are convex surfaces and both of the object side surfaces S13, S23, S33 and image side surfaces S14, S24, S34 are spherical surfaces.

The third lenses L13, L23, L33 are biconvex lenses with positive refractive power, wherein the object side surfaces S15, S25, S35 are convex surfaces, the image side surfaces S16, S26, S36 are convex surfaces, and both of the object side surfaces S15, S25, S35 and image side surfaces S16, S26, S36 are spherical surfaces.

The fourth lenses L14, L24, L34 are biconcave lenses with negative refractive power, wherein the object side surfaces S18, S28, S38 are concave surfaces, the image side surfaces S19, S29, S39 are concave surfaces, and both of the object side surfaces S18, S28, S38 and image side surfaces S19, S29, S39 are spherical surfaces.

The fifth lenses L15, L25, L35 are meniscus lenses with positive refractive power, wherein the object side surfaces S110, S210, S310 are concave surfaces, the image side surfaces S111, S211, S311 are convex surfaces, and both of the object side surfaces S110, S210, S310 and image side surfaces S111, S211, S311 are spherical surfaces.

The sixth lenses L16, L26, L36 are with positive refractive power, wherein the object side surfaces S112, S212, S312 are convex surfaces and both of the object side surfaces S112, S212, S312 and image side surfaces S113, S213, S313 are spherical surfaces.

In addition, the wide-angle lens assemblies 1, 2, and 3 satisfy at least one of the following conditions (1)-(10):

$$2 \leq Vd 1 / Vd 2 \leq 3 ; \qquad ( 1 )$$

$$3. 4 \leq TTL / BFL \leq 4.2 ; \qquad ( 2 )$$

$$1.03 \leq BFL / f \leq 1.22 ; \qquad ( 3 )$$

$$0.44 \leq \vert f / R 31 \vert \leq 0.57 ; \qquad ( 4 )$$

$$0.5 \leq R 52 / R 61 \leq 1.3 ; \qquad ( 5 )$$

$$2.2 \leq \vert R 21 / R 12 \vert \leq 6.3 ; \qquad ( 6 )$$

$$1. 35 \leq f 1 / f 4 \leq 2 \text{.05} ; \qquad ( 7 )$$

$$17.2 degrees / mm \leq FOV / f \leq 17.5 degrees / mm ; \qquad ( 8 )$$

$$45 degrees \leq FOV / Fno \leq 47 degrees ; \qquad ( 9 )$$

$$2.58 mm \leq f / Fno \leq 2.72 mm ; \qquad ( 10 )$$

wherein: f is an effective focal length of the wide-angle lens assemblies 1, 2, 3 for the first to third embodiments; f1 is an effective focal length of the first lenses L11, L21, L31 for the first to third embodiments; f4 is an effective focal length of the fourth lenses L14, L24, L34 for the first to third embodiments; R12 is a radius of curvature of the image side surfaces S12, S22, S32 of the first lenses L11, L21, L31 for the first to third embodiments; R21 is a radius of curvature of the object side surfaces S13, S23, S33 of the second lenses L12, L22, L32 for the first to third embodiments; R31 is a radius of curvature of the object side surfaces S15, S25, S35 of the third lenses L13, L23, L33 for the first to third embodiments; R52 is a radius of curvature of the image side surfaces S111, S211, S311 of the fifth lenses L15, L25, L35 for the first to third embodiments; R61 is a radius of curvature of the object side surfaces S112, S212, S312 of the sixth lenses L16, L26, L36 for the first to third embodiments; TTL is an interval from the object side surfaces S11, S21, S31 of the first lenses L11, L21, L31 to the image planes IMA1, IMA2, IMA3 along the optical axes OA1, OA2, OA3 for the first to third embodiments; BFL is an interval from the image side surfaces S113, S213, S313 of the sixth lenses L16, L26, L36 to the image planes IMA1, IMA2, IMA3 along the optical axes OA1, OA2, OA3 for the first to third embodiments; Vd1 is an Abbe number of the first lenses L11, L21, L31 for the first to third embodiments; Vd2 is an Abbe number of the second lenses L12, L22, L32 for the first to third embodiments; FOV is a maximum field of view of the wide-angle lens assemblies 1, 2, 3 for the first to third embodiments; and Fno is a F-number of the wide-angle lens assemblies 1, 2, 3 for the first to third embodiments. With the lens assemblies 1, 2, and 3 satisfying at least one of the above conditions (1)-(10), the field of view can be effectively increased, the resolution can be effectively increased, and the aberration can be effectively corrected.

When the condition (1): 2≤Vd1/Vd2≤3 is satisfied, the chromatic aberration can be corrected effectively and resolution can be increased effectively. When the condition (2): 3.4≤TTL/BFL≤4.2 is satisfied, the back focal length can be controlled effectively to improve production yield. When the conditions (3), (4), and (5): 1.03≤BFL/f≤1.22, 0.44≤|f/R31|≤0.57, and 0.5≤R52/R61≤1.3 are satisfied, the field curvature can be decreased effectively and resolution can be increased effectively. When the condition (6): 2.2≤|R21/R12|≤6.3 is satisfied, the resolution can be increased effectively. When the condition (7): 1.35≤f1/f4≤2.05 is satisfied, the light collection ability can be increased effectively. When the conditions (8), (9), and (10): 17.2 degrees/mm≤FOV/f≤17.5 degrees/mm, 45 degrees≤FOV/Fno≤47 degrees, and 2.58 mm≤f/Fno≤2.72 mm are satisfied, the diameter of the wide-angle lens assembly can be increased effectively and the brightness of the image can be increased effectively.

A detailed description of a wide-angle lens assembly in accordance with a first embodiment of the invention is as follows. Referring to FIG. 1, the wide-angle lens assembly 1 includes a first lens L11, a second lens L12, a third lens L13, a stop ST1, a fourth lens L14, a fifth lens L15, a sixth lens L16, an optical filter OF1, and a cover glass CG1, all of which are arranged in order from an object side to an image side along an optical axis OA1. In operation, the light from the object side is imaged on an image plane IMA1. According to the foregoing, wherein: the first lens L11 is a biconcave lens, wherein the object side surface S11 is a concave surface; the second lens L12 is a meniscus lens, wherein the image side surface S14 is a concave surface; the sixth lens L16 is a meniscus lens, wherein the image side surface S113 is a concave surface; both of the object side surface S114 and image side surface S115 of the optical filter OF1 are plane surfaces; both of the object side surface S116 and image side surface S117 of the cover glass CG1 are plane surfaces; and with the above design of the lenses, stop ST1, and at least one of the conditions (1)-(10) satisfied, the wide-angle lens assembly 1 can have an effective increased field of view, an effective increased resolution, and an effective corrected aberration. The wide-angle lens assembly 1 of the present invention can meet the basic operation requirements when it only satisfies condition (3), condition (4), condition (5), condition (8), condition (9), or condition (10), and the refractive surface shape characteristics of the independent claim.

Table 1 shows the optical specification of the wide-angle lens assembly 1 in FIG. 1.

TABLE 1
Effective Focal Length = 4.85 mm F-number = 1.85
Total Lens Length = 21.00 mm Field of View = 84.36 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S11 | −116.13 | 0.45 | 1.52 | 64.04 | −7.52 | L11 |
| S12 | 4.03 | 5.35 | | | | |
| S13 | 10.06 | 0.88 | 2.00 | 25.46 | 10.45 | L12 |
| S14 | 215.68 | 1.05 | | | | |
| S15 | 8.71 | 2.01 | 1.59 | 60.47 | 7.64 | L13 |
| S16 | −8.71 | −0.15 | | | | |
| S17 | ∞ | 0.53 | | | | ST1 |
| S18 | −7.71 | 1.86 | 1.95 | 17.98 | −3.81 | L14 |
| S19 | 7.71 | 0.37 | | | | |
| S110 | −148.76 | 0.95 | 2.05 | 26.94 | 7.61 | L15 |
| S111 | −7.66 | 0.05 | | | | |
| S112 | 6.12 | 2.35 | 1.73 | 54.67 | 13.19 | L16 |
| S113 | 14.05 | 1.00 | | | | |
| S114 | ∞ | 0.40 | 1.52 | 64.17 | | OF1 |
| S115 | ∞ | 2.50 | | | | |
| S116 | ∞ | 0.40 | 1.52 | 64.17 | | CG1 |
| S117 | ∞ | 1.02 | | | | |

Table 2 shows the parameters and condition values for conditions (1)-(10) in accordance with the first embodiment of the invention. It can be seen from Table 2 that the wide-angle lens assembly 1 of the first embodiment satisfies the conditions (1)-(10).

TABLE 2

| BFL | 5.32 | mm | Vd1/Vd2 | 2.52 | TTL/BFL | 3.95 |
|---|---|---|---|---|---|---|
| BFL/f | 1.10 | | \|f/R31\| | 0.56 | R52/R61 | −1.25 |
| \|R21/R12\| | 2.49 | | f1/f4 | 1.97 | FOV/f | 17.39 degrees/mm |
| FOV/Fno | 45.6 | degrees | f/Fno | 2.62 mm | | |

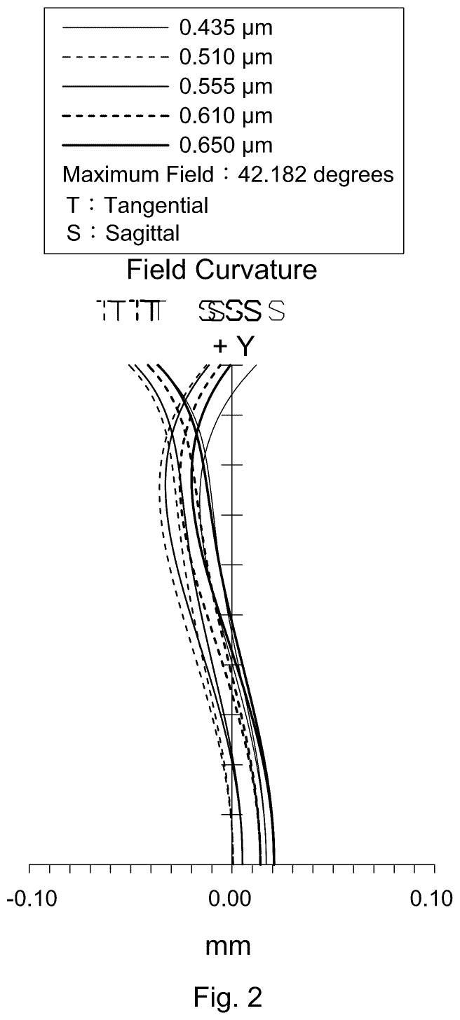

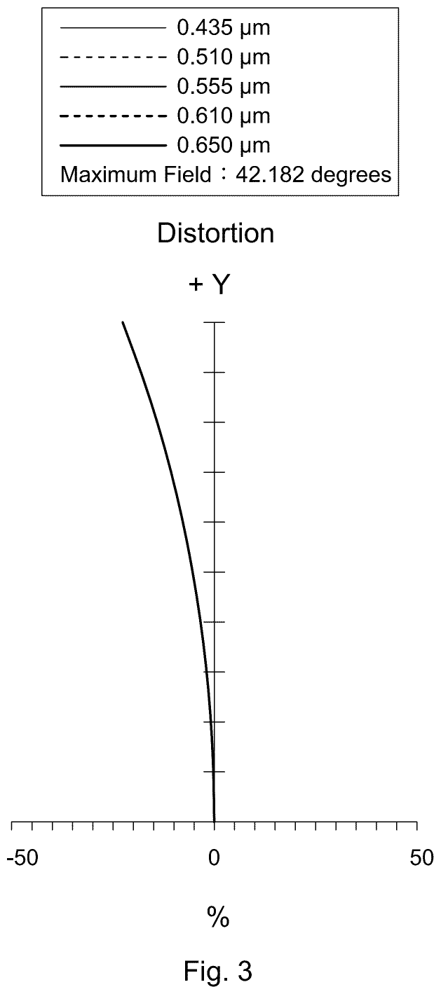

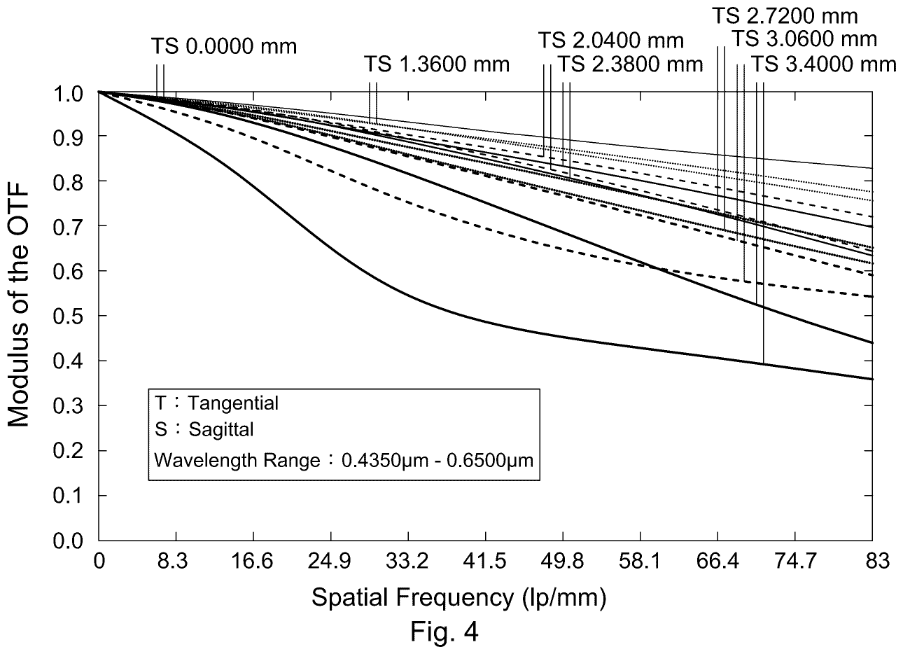

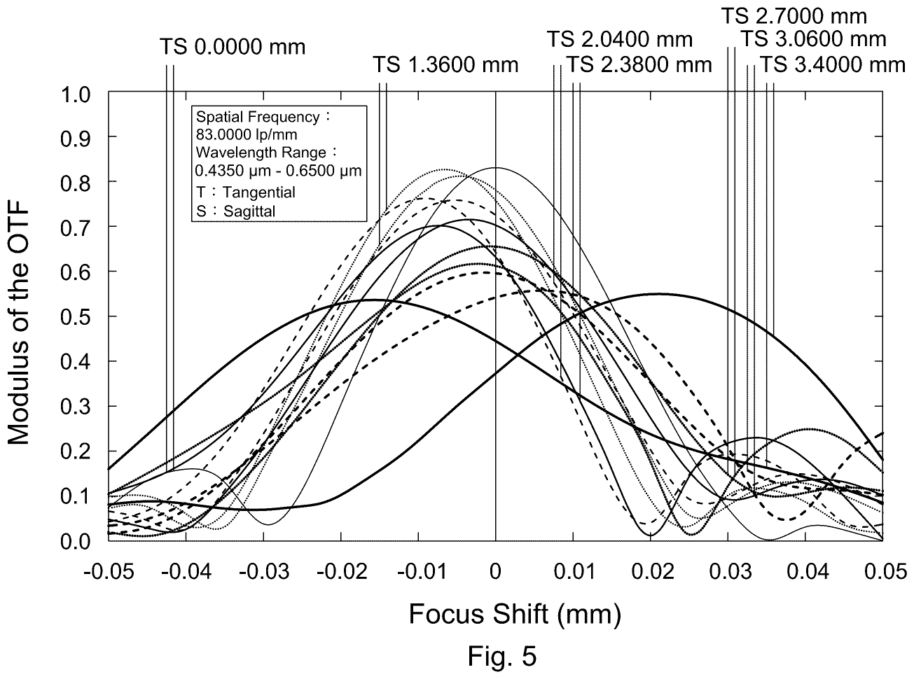

In addition, the wide-angle lens assembly 1 of the first embodiment can meet the requirements of optical performance as seen in FIGS. 2-5. It can be seen from FIG. 2 that the field curvature of tangential direction and sagittal direction in the wide-angle lens assembly 1 of the first embodiment ranges from −0.06 mm to 0.03 mm. It can be seen from FIG. 3 that the distortion in the wide-angle lens assembly 1 of the first embodiment ranges from −25% to 0%. It can be seen from FIG. 4 that the modulation transfer function of tangential direction and sagittal direction in the wide-angle lens assembly 1 of the first embodiment ranges from 0.36 to 1.0. It can be seen from FIG. 5 that the through focus modulation transfer function of tangential direction and sagittal direction in the wide-angle lens assembly 1 of the first embodiment ranges from 0.0 to 0.83 as focus shift ranges from −0.05 mm to 0.05 mm. It is obvious that the field curvature and the distortion of the wide-angle lens assembly 1 of the first embodiment can be corrected effectively, and the resolution and the depth of focus of the wide-angle lens assembly 1 of the first embodiment can meet the requirement. Therefore, the wide-angle lens assembly 1 of the first embodiment is capable of good optical performance.

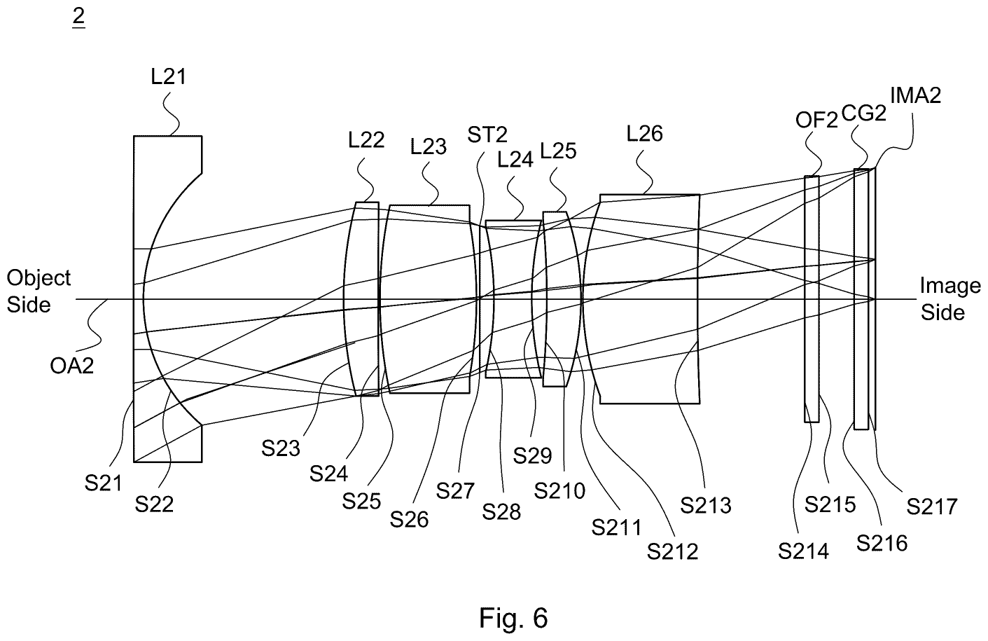

A detailed description of a wide-angle lens assembly in accordance with a second embodiment of the invention is as follows. Referring to FIG. 6, the wide-angle lens assembly 2 includes a first lens L21, a second lens L22, a third lens L23, a stop ST2, a fourth lens L24, a fifth lens L25, a sixth lens L26, an optical filter OF2, and a cover glass CG2, all of which are arranged in order from an object side to an image side along an optical axis OA2. In operation, the light from the object side is imaged on an image plane IMA2. According to the foregoing, wherein: the first lens L21 is a meniscus lens, wherein the object side surface S21 is a convex surface; the second lens L22 is a meniscus lens, wherein the image side surface S24 is a concave surface; the sixth lens L26 is a meniscus lens, wherein the image side surface S213 is a concave surface; both of the object side surface S214 and image side surface S215 of the optical filter OF2 are plane surfaces; both of the object side surface S216 and image side surface S217 of the cover glass CG2 are plane surfaces; and with the above design of the lenses, stop ST2, and at least one of the conditions (1)-(10) satisfied, the wide-angle lens assembly 2 can have an effective increased field of view, an effective increased resolution, and an effective corrected aberration. The wide-angle lens assembly 2 of the present invention can meet the basic operation requirements when it only satisfies condition (1) or condition (2), and the refractive surface shape characteristics of the independent claim.

Table 3 shows the optical specification of the wide-angle lens assembly 2 in FIG. 6.

TABLE 3
Effective Focal Length = 4.83 mm F-number = 1.86
Total Lens Length = 21.00 mm Field of View = 84.00 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S21 | 796.09 | 0.30 | 1.52 | 64.14 | −7.85 | L21 |
| S22 | 4.05 | 5.66 | | | | |
| S23 | 9.19 | 0.97 | 2.00 | 25.46 | 9.44 | L22 |
| S24 | 257.29 | 0.05 | | | | |
| S25 | 10.59 | 2.73 | 1.60 | 67.74 | 9.32 | L23 |
| S26 | −10.59 | 0.09 | | | | |
| S27 | ∞ | 0.40 | | | | ST2 |
| S28 | −7.77 | 1.07 | 1.96 | 17.47 | −3.88 | L24 |
| S29 | 7.77 | 0.43 | | | | |
| S210 | −19.41 | 0.97 | 2.00 | 29.14 | 8.68 | L25 |
| S211 | −6.18 | 0.05 | | | | |
| S212 | 6.69 | 3.24 | 1.73 | 54.67 | 10.02 | L26 |
| S213 | 61.20 | 3.03 | | | | |
| S214 | ∞ | 0.40 | 1.52 | 64.17 | | OF2 |
| S215 | ∞ | 1.00 | | | | |
| S216 | ∞ | 0.40 | 1.52 | 64.17 | | CG2 |
| S217 | ∞ | 0.20 | | | | |

Table 4 shows the parameters and condition values for conditions (1)-(10) in accordance with the second embodiment of the invention. It can be seen from Table 4 that the wide-angle lens assembly 2 of the second embodiment satisfies the conditions (1)-(10).

TABLE 4

| BFL | 5.03 | mm | Vd1/Vd2 | 2.52 | TTL/BFL | 4.17 |
|---|---|---|---|---|---|---|
| BFL/f | 1.04 | | \|f/R31\| | 0.46 | R52/R61 | −0.92 |
| \|R21/R12\| | 2.27 | | f1/f4 | 2.02 | FOV/f | 17.39 degrees/mm |
| FOV/Fno | 45.16 | degrees | f/Fno | 2.6 mm | | |

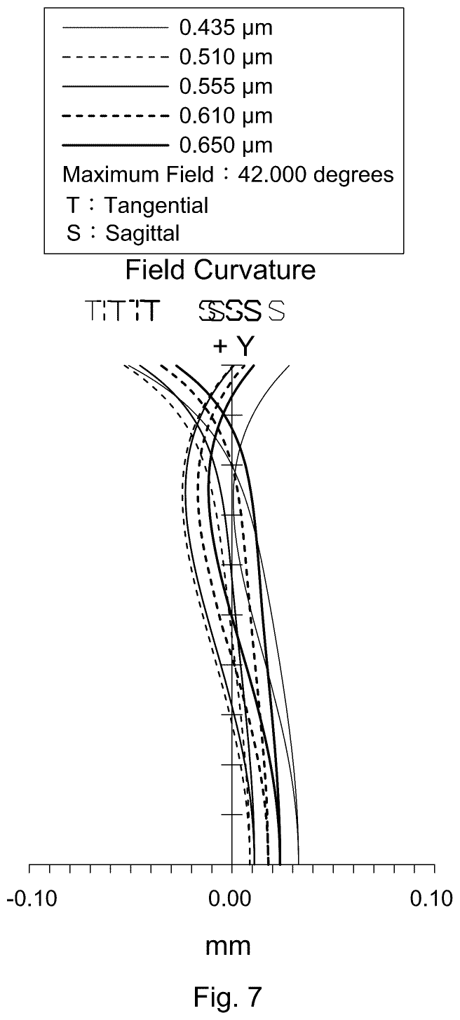

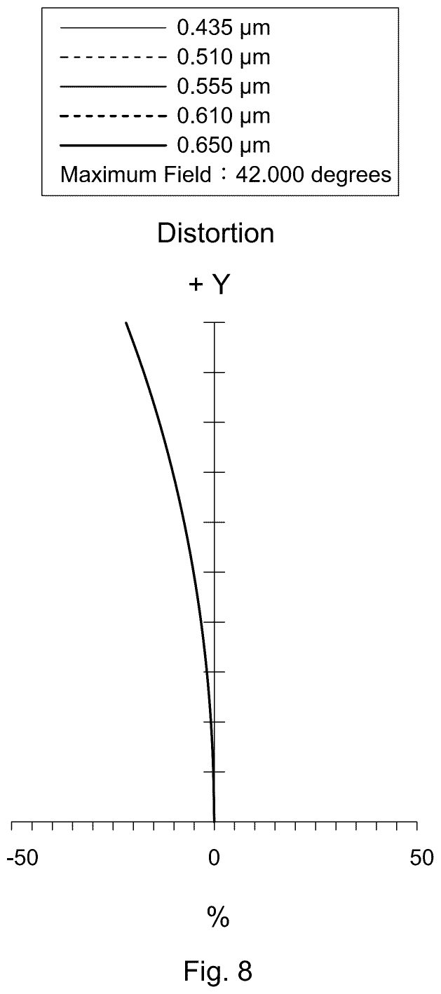

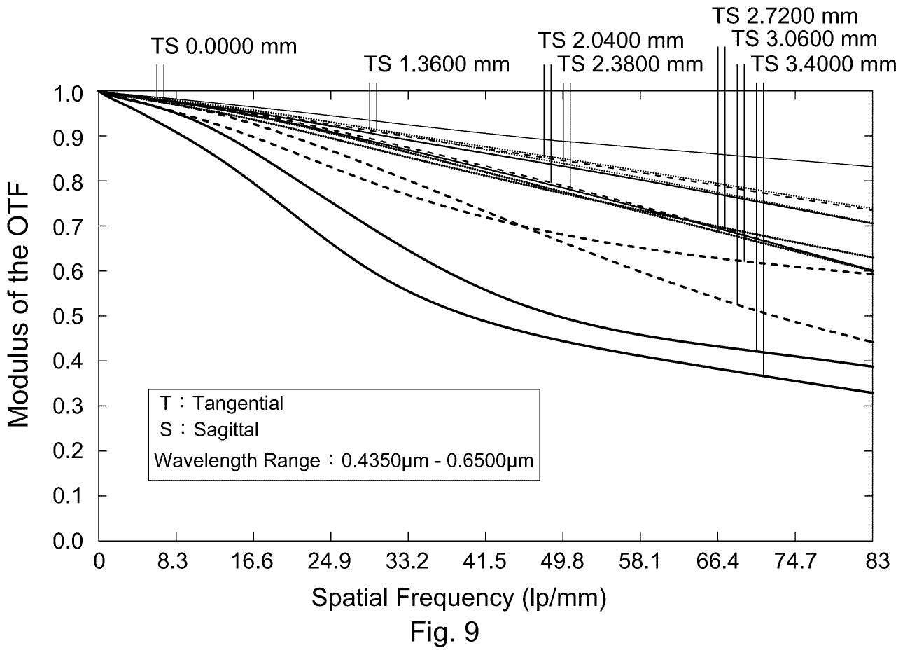

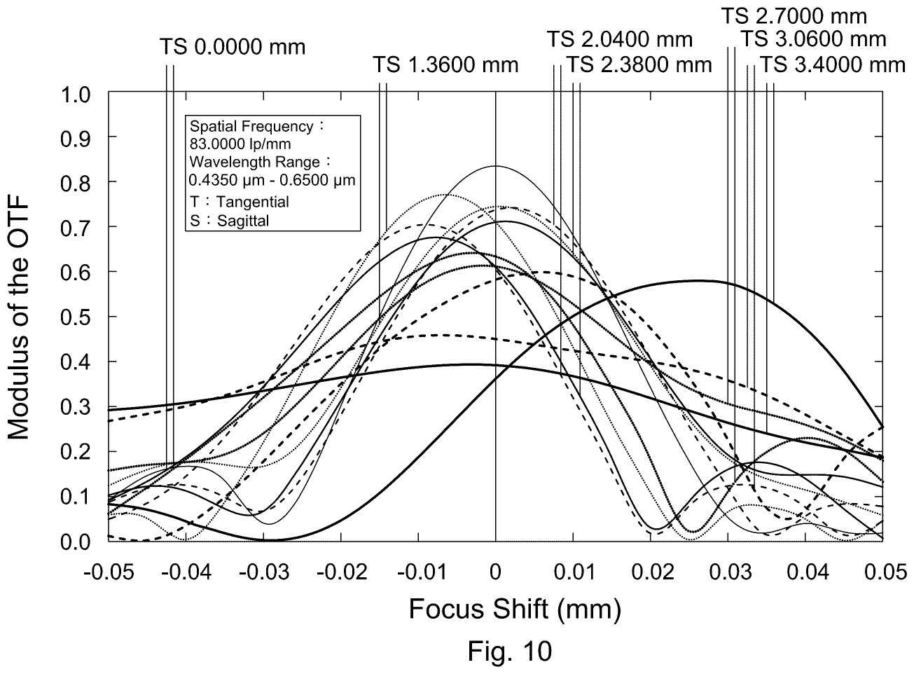

In addition, the wide-angle lens assembly 2 of the second embodiment can meet the requirements of optical performance as seen in FIGS. 7-10. It can be seen from FIG. 7 that the field curvature of tangential direction and sagittal direction in the wide-angle lens assembly 2 of the second embodiment ranges from −0.06 mm to 0.04 mm. It can be seen from FIG. 8 that the distortion in the wide-angle lens assembly 2 of the second embodiment ranges from −25% to 0%. It can be seen from FIG. 9 that the modulation transfer function of tangential direction and sagittal direction in the wide-angle lens assembly 2 of the second embodiment ranges from 0.33 to 1.0. It can be seen from FIG. 10 that the through focus modulation transfer function of tangential direction and sagittal direction in the wide-angle lens assembly 2 of the second embodiment ranges from 0.0 to 0.83 as focus shift ranges from −0.05 mm to 0.05 mm. It is obvious that the field curvature and the distortion of the wide-angle lens assembly 2 of the second embodiment can be corrected effectively, and the resolution and the depth of focus of the wide-angle lens assembly 2 of the second embodiment can meet the requirement. Therefore, the wide-angle lens assembly 2 of the second embodiment is capable of good optical performance.

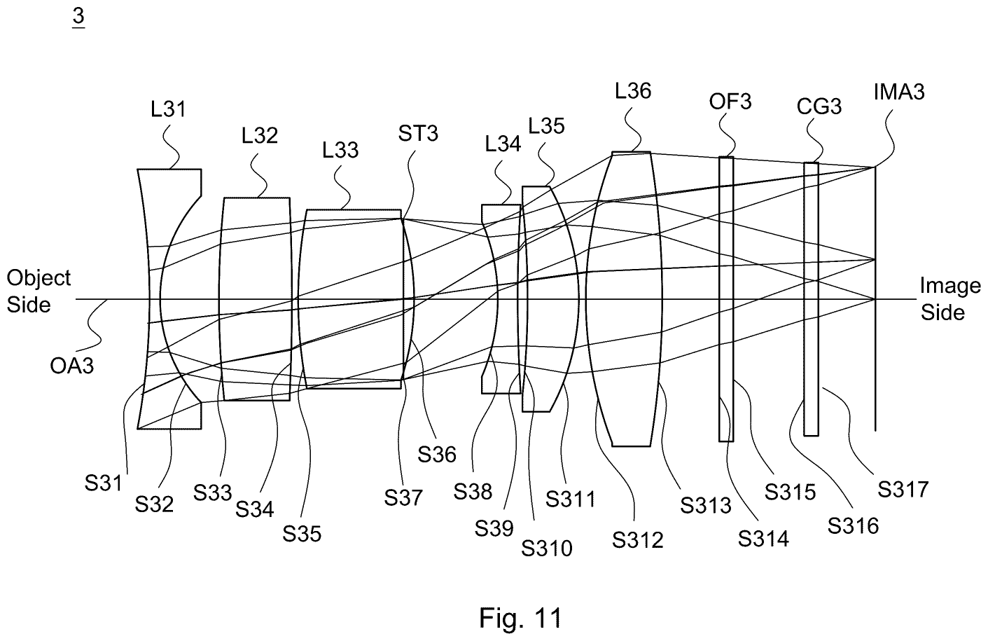

A detailed description of a wide-angle lens assembly in accordance with a third embodiment of the invention is as follows. Referring to FIG. 11, the wide-angle lens assembly 3 includes a first lens L31, a second lens L32, a third lens L33, a stop ST3, a fourth lens L34, a fifth lens L35, a sixth lens L36, an optical filter OF3, and a cover glass CG3, all of which are arranged in order from an object side to an image side along an optical axis OA3. In operation, the light from the object side is imaged on an image plane IMA3. According to the foregoing, wherein: the first lens L31 is a biconcave lens, wherein the object side surface S31 is a concave surface; the second lens L32 is a biconvex lens, wherein the image side surface S34 is a convex surface; the sixth lens L36 is a biconvex lens, wherein the image side surface S313 is a convex surface; both of the object side surface S314 and image side surface S315 of the optical filter OF3 are plane surfaces; both of the object side surface S316 and image side surface S317 of the cover glass CG3 are plane surfaces; and with the above design of the lenses, stop ST3, and at least one of the conditions (1)-(10) satisfied, the wide-angle lens assembly 3 can have an effective increased field of view, an effective increased resolution, and an effective corrected aberration. The wide-angle lens assembly 3 of the present invention can meet the basic operation requirements when it only satisfies condition (6) or condition (7), and the refractive surface shape characteristics of the independent claim.

Table 5 shows the optical specification of the wide-angle lens assembly 3 in FIG. 11.

TABLE 5
Effective Focal Length = 4.96 mm F-number = 1.84
Total Lens Length = 20.49 mm Field of View = 85.86 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S31 | −16.16 | 0.29 | 1.52 | 64.14 | −5.68 | L31 |
| S32 | 3.61 | 1.67 | | | | |
| S33 | 22.44 | 2.06 | 2.00 | 25.46 | 15.51 | L32 |
| S34 | −49.13 | 0.18 | | | | |
| S35 | 10.99 | 3.28 | 1.60 | 67.74 | 7.03 | L33 |
| S36 | −6.03 | −0.30 | | | | |
| S37 | ∞ | 2.69 | | | | ST3 |
| S38 | −4.46 | 0.54 | 1.96 | 17.47 | −4.06 | L34 |
| S39 | 35.21 | 0.28 | | | | |
| S310 | −20.69 | 1.46 | 2.00 | 29.14 | 6.95 | L35 |
| S311 | −5.42 | 0.18 | | | | |
| S312 | 9.53 | 2.17 | 1.77 | 49.60 | 8.70 | L36 |
| S313 | −20.76 | 1.60 | | | | |
| S314 | ∞ | 0.40 | 1.52 | 64.17 | | OF3 |
| S315 | ∞ | 2.00 | | | | |
| S316 | ∞ | 0.40 | 1.52 | 64.17 | | CG3 |
| S317 | ∞ | 1.61 | | | | |

Table 6 shows the parameters and condition values for conditions (1)-(10) in accordance with the third embodiment of the invention. It can be seen from Table 6 that the wide-angle lens assembly 3 of the third embodiment satisfies the conditions (1)-(10).

TABLE 6

| BFL | 6.01 | mm | Vd1/Vd2 | 2.52 | TTL/BFL | 3.41 |
|---|---|---|---|---|---|---|
| BFL/f | 1.21 | | \|f/R31\| | 0.45 | R52/R61 | −0.57 |
| \|R21/R12\| | 6.21 | | f1/f4 | 1.40 | FOV/f | 17.31 degrees/mm |
| FOV/Fno | 46.66 | degrees | f/Fno | 2.7 mm | | |

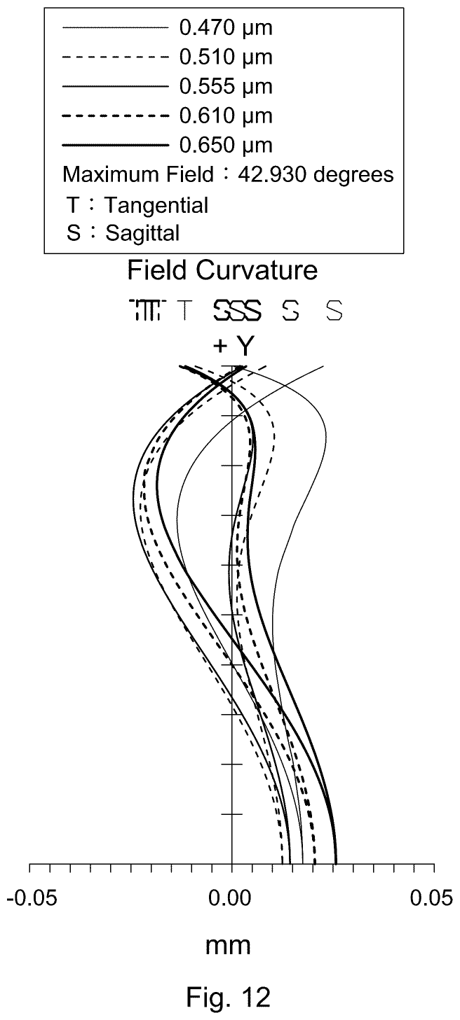

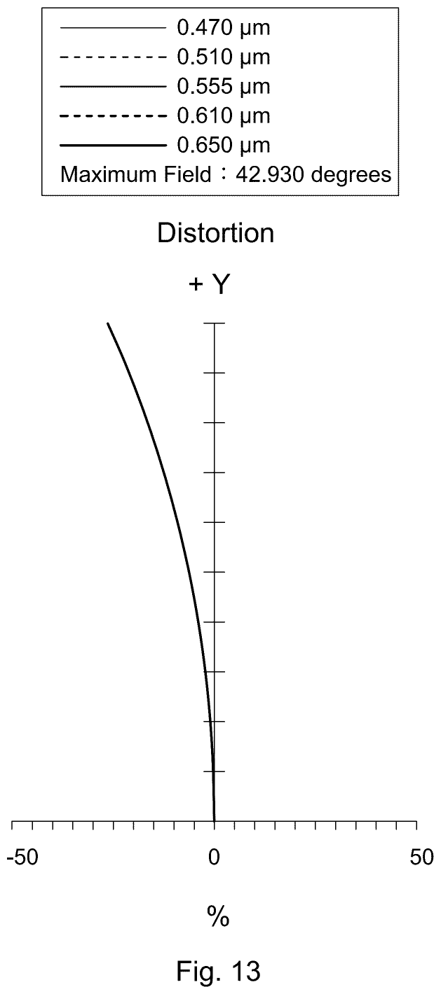

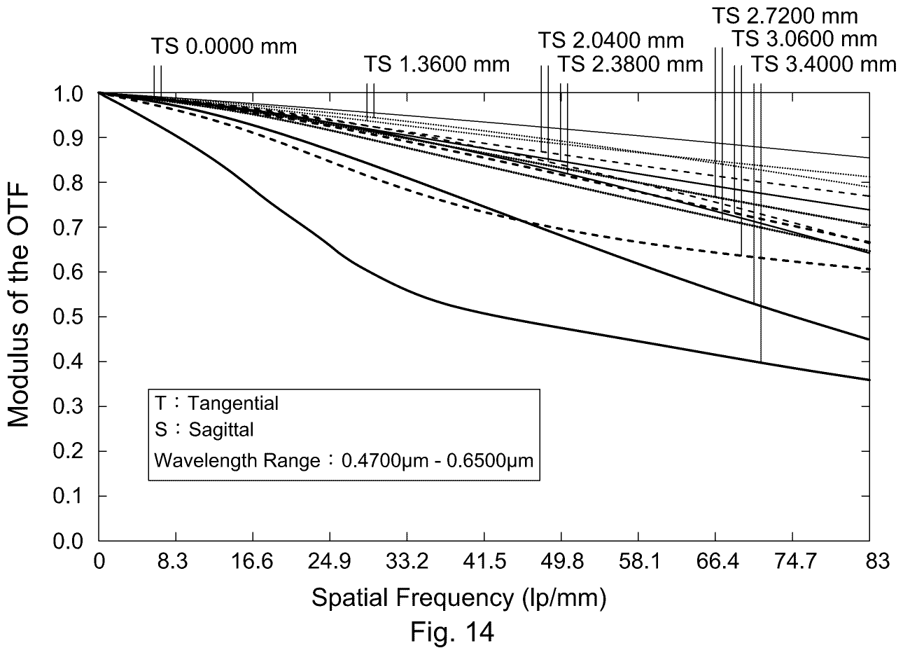

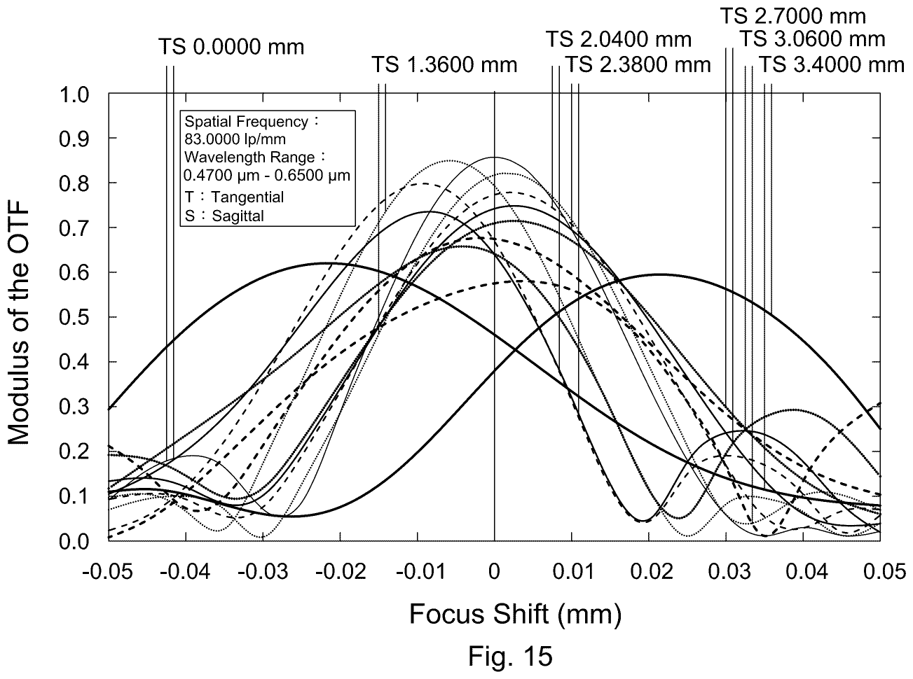

In addition, the wide-angle lens assembly 3 of the third embodiment can meet the requirements of optical performance as seen in FIGS. 12-15. It can be seen from FIG. 12 that the field curvature of tangential direction and sagittal direction in the wide-angle lens assembly 3 of the third embodiment ranges from −0.025 mm to 0.03 mm. It can be seen from FIG. 13 that the distortion in the wide-angle lens assembly 3 of the third embodiment ranges from −30% to 0%. It can be seen from FIG. 14 that the modulation transfer function of tangential direction and sagittal direction in the wide-angle lens assembly 3 of the third embodiment ranges from 0.37 to 1.0. It can be seen from FIG. 15 that the through focus modulation transfer function of tangential direction and sagittal direction in the wide-angle lens assembly 3 of the third embodiment ranges from 0.01 to 0.85 as focus shift ranges from −0.05 mm to 0.05 mm. It is obvious that the field curvature and the distortion of the wide-angle lens assembly 3 of the third embodiment can be corrected effectively, and the resolution and the depth of focus of the wide-angle lens assembly 3 of the third embodiment can meet the requirement. Therefore, the wide-angle lens assembly 3 of the third embodiment is capable of good optical performance.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wide-angle lens assembly comprising:
a first lens which is with negative refractive power;
a second lens which is with refractive power;
a third lens which is with positive refractive power;
a fourth lens which is with negative refractive power and comprises a concave surface facing an image side;
a fifth lens which is with refractive power and comprises a convex surface facing the image side; and
a sixth lens which is with refractive power and comprises a convex surface facing an object side;
wherein the first lens, the second lens, the third lens, the fourth lens, the fifth lens, and the sixth lens are arranged in order from the object side to the image side along an optical axis;
wherein the wide-angle lens assembly satisfies at least one of following conditions:
$$1.03 \leq BFL / f \leq 1.22 ;$$
$$0.5 \leq R 52 / R 61 \leq 1.3 ;$$
$$17.2 degrees / mm \leq FOV / f \leq 17.5 degrees / mm ;$$
$$45 degrees \leq FOV / Fno \leq 47 degrees ;$$
$$2.58 mm \leq f / Fno \leq 2.72 mm ;$$
wherein f is an effective focal length of the wide-angle lens assembly, R52 is a radius of curvature of an image side surface of the fifth lens, R61 is a radius of curvature of an object side surface of the sixth lens, BFL is an interval from an image side surface of the sixth lens to an image plane along the optical axis, FOV is a maximum field of view of the wide-angle lens assembly, and Fno is a F-number of the wide-angle lens assembly.

2. The wide-angle lens assembly as claimed in claim 1, wherein the wide-angle lens assembly satisfies at least one of following conditions:
$$2 \leq Vd 1 / Vd 2 \leq 3 ;$$
$$3.4 \leq TTL / BFL \leq 4.2 ;$$
$$2.2 \leq \vert R 21 / R 12 \vert \leq 6.3 ;$$
$$1.35 \leq f 1 / f 4 \leq 2 \text{.05} ;$$
$$0.44 \leq \vert f / R 31 \vert \leq 0.57 ;$$
wherein Vd1 is an Abbe number of the first lens, Vd2 is an Abbe number of the second lens, TTL is an interval from an object side surface of the first lens to the image plane along the optical axis, BFL is the interval from the image side surface of the sixth lens to the image plane along the optical axis, R12 is a radius of curvature of an image side surface of the first lens, R21 is a radius of curvature of an object side surface of the second lens, f1 is an effective focal length of the first lens, and f4 is an effective focal length of the fourth lens, R31 is a radius of curvature of an object side surface of the third lens, f is an effective focal length of the wide-angle lens assembly.

3. The wide-angle lens assembly as claimed in claim 1, wherein:
the second lens is with positive refractive power;
the fifth lens is with positive refractive power; and
the sixth lens is with positive refractive power.

4. The wide-angle lens assembly as claimed in claim 3, wherein the wide-angle lens assembly satisfies at least one of following conditions:
$$2 \leq Vd 1 / Vd 2 \leq 3 ;$$
$$3.4 \leq TTL / BFL \leq 4.2 ;$$
$$2.2 \leq \vert R 21 / R 12 \vert \leq 6.3 ;$$
$$1.35 \leq f 1 / f 4 \leq 2 \text{.05} ;$$
$$0.44 \leq \vert f / R 31 \vert \leq 0.57 ;$$
wherein Vd1 is an Abbe number of the first lens, Vd2 is an Abbe number of the second lens, TTL is an interval from an object side surface of the first lens to the image plane along the optical axis, BFL is the interval from the image side surface of the sixth lens to the image plane along the optical axis, R12 is a radius of curvature of an image side surface of the first lens, R21 is a radius of curvature of an object side surface of the second lens, f1 is an effective focal length of the first lens, and f4 is an effective focal length of the fourth lens, R31 is a radius of curvature of an object side surface of the third lens, f is an effective focal length of the wide-angle lens assembly.

5. The wide-angle lens assembly as claimed in claim 3, wherein:
the first lens comprises a concave surface facing the image side;
the second lens comprises a convex surface facing the object side;
the third lens is a biconvex lens and comprises a convex surface facing the object side and another convex surface facing the image side;
the fourth lens is a biconcave lens and further comprises another concave surface facing the object side; and
the fifth lens is a meniscus lens and further comprises a concave surface facing the objet side.

6. The wide-angle lens assembly as claimed in claim 5, wherein the wide-angle lens assembly satisfies at least one of following conditions:
$$2 \leq Vd 1 / Vd 2 \leq 3 ;$$
$$3.4 \leq TTL / BFL \leq 4.2 ;$$
$$2.2 \leq \vert R 21 / R 12 \vert \leq 6.3 ;$$
$$1.35 \leq f 1 / f 4 \leq 2 \text{.05} ;$$
$$0.44 \leq \vert f / R 31 \vert \leq 0.57 ;$$
wherein Vd1 is an Abbe number of the first lens, Vd2 is an Abbe number of the second lens, TTL is an interval from an object side 10 surface of the first lens to the image plane along the optical axis, BFL 11 is the interval from the image side surface of the sixth lens to the image plane along the optical axis, R12 is a radius of curvature of an image side surface of the first lens, R21 is a radius of curvature of an object side surface of the second lens, f1 is an effective focal length of the first lens, and f4 is an effective focal length of the fourth lens, R31 is a radius of curvature of an object side surface of the third lens, f is an effective focal length of the wide-angle lens assembly.

7. The wide-angle lens assembly as claimed in claim 5, wherein:
the second lens is a meniscus lens and further comprises a concave surface facing the image side; and
the sixth lens is a meniscus lens and further comprises a concave surface facing the image side.

8. The wide-angle lens assembly as claimed in claim 7, wherein the wide-angle lens assembly satisfies at least one of following conditions:
$$2 \leq Vd 1 / Vd 2 \leq 3 ;$$
$$3.4 \leq TTL / BFL \leq 4.2 ;$$
$$2.2 \leq \vert R 21 / R 12 \vert \leq 6.3 ;$$
$$1.35 \leq f 1 / f 4 \leq 2 \text{.05} ;$$
$$0.44 \leq \vert f / R 31 \vert \leq 0.57 ;$$
wherein Vd1 is an Abbe number of the first lens, Vd2 is an Abbe number of the second lens, TTL is an interval from an object side surface of the first lens to the image plane along the optical axis, BFL is the interval from the image side surface of the sixth lens to the image plane along the optical axis, R12 is a radius of curvature of an image side surface of the first lens, R21 is a radius of curvature of an object side surface of the second lens, f1 is an effective focal length of the first lens, and f4 is an effective focal length of the fourth lens, R31 is a radius of curvature of an object side surface of the third lens, f is an effective focal length of the wide-angle lens assembly.

9. The wide-angle lens assembly as claimed in claim 5, wherein the first lens is a biconcave lens and further comprises another concave surface facing the object side.

10. The wide-angle lens assembly as claimed in claim 9, wherein the wide-angle lens assembly satisfies at least one of following conditions:
$$2 \leq Vd 1 / Vd 2 \leq 3 ;$$
$$3.4 \leq TTL / BFL \leq 4.2 ;$$
$$2.2 \leq \vert R 21 / R 12 \vert \leq 6.3 ;$$
$$1.35 \leq f 1 / f 4 \leq 2 \text{.05} ;$$
$$0.44 \leq \vert f / R 31 \vert \leq 0.57 ;$$
wherein Vd1 is an Abbe number of the first lens, Vd2 is an Abbe number of the second lens, TTL is an interval from an object side surface of the first lens to the image plane along the optical axis, BFL is the interval from the image side surface of the sixth lens to the image plane along the optical axis, R12 is a radius of curvature of an image side surface of the first lens, R21 is a radius of curvature of an object side surface of the second lens, f1 is an effective focal length of the first lens, and f4 is an effective focal length of the fourth lens, R31 is a radius of curvature of an object side surface of the third lens, f is an effective focal length of the wide-angle lens assembly.

11. The wide-angle lens assembly as claimed in claim 5, wherein:
the second lens is a biconvex lens and further comprises another convex surface facing the image side; and
the sixth lens is a biconvex lens and further comprises another convex surface facing the image side.

12. The wide-angle lens assembly as claimed in claim 11, wherein the wide-angle lens assembly satisfies at least one of following conditions:
$$2 \leq Vd 1 / Vd 2 \leq 3 ;$$
$$3.4 \leq TTL / BFL \leq 4.2 ;$$
$$2.2 \leq \vert R 21 / R 12 \vert \leq 6.3 ;$$
$$1.35 \leq f 1 / f 4 \leq 2 \text{.05} ;$$
$$0.44 \leq \vert f / R 31 \vert \leq 0.57 ;$$
wherein Vd1 is an Abbe number of the first lens, Vd2 is an Abbe number of the second lens, TTL is an interval from an object side surface of the first lens to the image plane along the optical axis, BFL is the interval from the image side surface of the sixth lens to the image plane along the optical axis, R12 is a radius of curvature of an image side surface of the first lens, R21 is a radius of curvature of an object side surface of the second lens, f1 is an effective focal length of the first lens, and f4 is an effective focal length of the fourth lens, R31 is a radius of curvature of an object side surface of the third lens, f is an effective focal length of the wide-angle lens assembly.

13. The wide-angle lens assembly as claimed in claim 7, wherein the first lens is a meniscus lens and further comprises a convex surface facing the object side.

14. The wide-angle lens assembly as claimed in claim 13, wherein the wide-angle lens assembly satisfies at least one of following conditions:
$$2 \leq Vd 1 / Vd 2 \leq 3 ;$$
$$3.4 \leq TTL / BFL \leq 4.2 ;$$
$$2.2 \leq \vert R 21 / R 12 \vert \leq 6.3 ;$$
$$1.35 \leq f 1 / f 4 \leq 2 \text{.05} ;$$
$$0.44 \leq \vert f / R 31 \vert \leq 0.57 ;$$
wherein Vd1 is an Abbe number of the first lens, Vd2 is an Abbe number of the second lens, TTL is an interval from an object side 10 surface of the first lens to the image plane along the optical axis, BFL 11 is the interval from the image side surface of the sixth lens to the 12 image plane along the optical axis, R12 is a radius of curvature of an 13 image side surface of the first lens, R21 is a radius of curvature of an object side surface of the second lens, f1 is an effective focal length of the first lens, and f4 is an effective focal length of the fourth lens, R31 is a radius of curvature of an object side surface of the third lens, f is an effective focal length of the wide-angle lens assembly.

15. The wide-angle lens assembly as claimed in claim 1, further comprising a stop disposed between the third lens and the fourth lens.

16. The wide-angle lens assembly as claimed in claim 15, wherein the wide-angle lens assembly satisfies at least one of following conditions:
$$2 \leq Vd 1 / Vd 2 \leq 3 ;$$
$$3.4 \leq TTL / BFL \leq 4.2 ;$$
$$2.2 \leq \vert R 21 / R 12 \vert \leq 6.3 ;$$
$$1.35 \leq f 1 / f 4 \leq 2 \text{.05} ;$$
$$0.44 \leq \vert f / R 31 \vert \leq 0.57 ;$$
wherein Vd1 is an Abbe number of the first lens, Vd2 is an Abbe number of the second lens, TTL is an interval from an object side surface of the first lens to the image plane along the optical axis, BFL is the interval from the image side surface of the sixth lens to the image plane along the optical axis, R12 is a radius of curvature of an image side surface of the first lens, R21 is a radius of curvature of an object side surface of the second lens, f1 is an effective focal length of the first lens, and f4 is an effective focal length of the fourth lens, R31 is a radius of curvature of an object side surface of the third lens, f is an effective focal length of the wide-angle lens assembly.

17. The wide-angle lens assembly as claimed in claim 1, wherein:
the first lens is a meniscus lens or a biconcave lens;
when the first lens is the meniscus lens, then the sixth lens is also a meniscus lens; when the first lens is the biconcave lens, then a shape of an object side surface of the second lens is similar to a shape of an object side surface of the six lens, and a shape of an image side surface of the second lens is similar to a shape of an image side surface of the six lens.

18. A wide-angle lens assembly comprising:
a first lens which is with negative refractive power;
a second lens which is with refractive power;
a third lens which is with positive refractive power;
a fourth lens which is with negative refractive power and comprises a concave surface facing an image side;
a fifth lens which is with refractive power and comprises a convex surface facing the image side; and
a sixth lens which is with refractive power and comprises a convex surface facing an object side;
wherein the first lens, the second lens, the third lens, the fourth lens, the fifth lens, and the sixth lens are arranged in order from the object side to the image side along an optical axis;
wherein the first lens is a meniscus lens or a biconcave lens; when the first lens is the meniscus lens, then the sixth lens is also a meniscus lens; when the first lens is the biconcave lens, then a shape of an object side surface of the second lens is similar to a shape of an object side surface of the six lens, and a shape of an image side surface of the second lens is similar to a shape of an image side surface of the six lens.

19. The wide-angle lens assembly as claimed in claim 17, wherein the wide-angle lens assembly satisfies at least one of following conditions:
$$2 \leq Vd 1 / Vd 2 \leq 3 ;$$
$$3.4 \leq TTL / BFL \leq 4.2 ;$$
$$2.2 \leq \vert R 21 / R 12 \vert \leq 6.3 ;$$
$$1.35 \leq f 1 / f 4 \leq 2 \text{.05} ;$$
$$0.44 \leq \vert f / R 31 \vert \leq 0.57 ;$$
$$1.03 \leq BFL / f \leq 1.22 ;$$
$$0.5 \leq R 52 / R 61 \leq 1.3 ;$$
$$17.2 degrees / mm \leq FOV / f \leq 17.5 degrees / mm ;$$
$$45 degrees \leq FOV / Fno \leq 47 degrees ;$$
$$2.58 mm \leq f / Fno \leq 2.72 mm ;$$
wherein Vd1 is an Abbe number of the first lens, Vd2 is an Abbe number of the second lens, TTL is an interval from an object side surface of the first lens to the image plane along the optical axis, BFL is the interval from the image side surface of the sixth lens to the image plane along the optical axis, R12 is a radius of curvature of an image side surface of the first lens, R21 is a radius of curvature of an object side surface of the second lens, f1 is an effective focal length of the first lens, and f4 is an effective focal length of the fourth lens, R31 is a radius of curvature of an object side surface of the third lens, f is an effective focal length of the wide-angle lens assembly, R52 is a radius of curvature of an image side surface of the fifth lens, R61 is a radius of curvature of an object side surface of the sixth lens, BFL is an interval from an image side surface of the sixth lens to an image plane along the optical axis, FOV is a maximum field of view of the wide-angle lens assembly, and Fno is a F-number of the wide-angle lens assembly.
